(19) United States
(12) Patent Application Publication
(10) Pub. No.: US 2014/0283598 A1
(43) Pub. Date: Sep. 25, 2014

(54) DYNAMIC BALANCE DETECTING DEVICE

(71) Applicants: HON HAI PRECISION INDUSTRY CO., LTD., New Taipei (TW); HONG FU JIN PRECISION INDUSTRY (ShenZhen) CO., LTD, Shenzhen (CN)

(72) Inventors: GANG LIU, Shenzhen (CN); JI-DONG DING, Shenzhen (CN); JUN ZHANG, Shenzhen (CN); XIAO-DONG WANG, Shenzhen (CN); GUO-XUAN ZHANG, Shenzhen (CN); XUE-FEI PENG, Shenzhen (CN); ZHONG-HUA HE, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 14/093,626

(22) Filed: Dec. 2, 2013

(30) Foreign Application Priority Data
Mar. 20, 2013 (CN) 2013100896202

(51) Int. Cl. G01M 1/16

(52) U.S. Cl. CPC G01M 1/16
USPC 73/460

(57) ABSTRACT

The dynamic balance detecting device includes a platform, a pillar, a main shaft, a vibration sensor, a rotation sensor, a dynamic measuring tester, and a controller. The pillar is connected to the platform. The main shaft is positioned on the pillar for driving a rotor. The vibration sensor is positioned adjacent to the main shaft for detecting vibration amount of the main shaft. The rotation sensor is positioned adjacent to the main shaft and spaced from the vibration sensor for detecting a rotation of the main shaft. The dynamic measuring tester is positioned on the platform for receiving vibration data obtained by the vibration sensor and rotation data obtained by the rotation sensor in real time to analyze and determine whether dynamic balance of the rotor achieving as required, and calculates a dynamic balance regulating amount for the rotor.

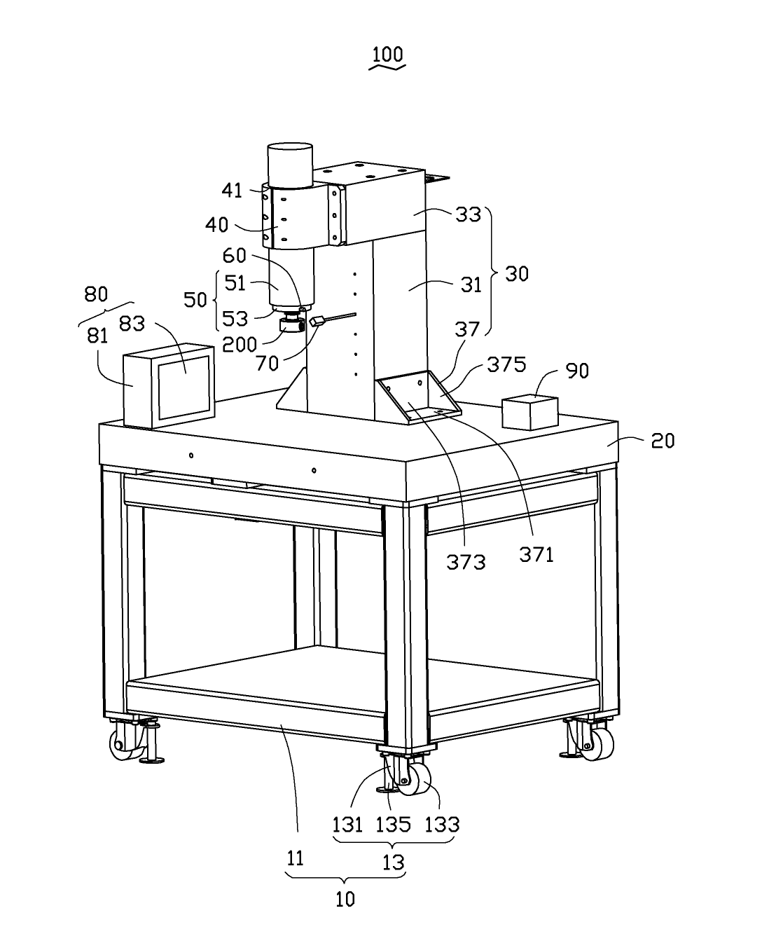

### BACKGROUND

1. Technical Field

The present disclosure generally relates to detecting devices, and particularly to a dynamic balance detecting device for rotors.

2. Description of the Related Art

Rotor vibrations affect the lifetime and machining accuracy of machines. Non-uniform distributions of mass about the spin axis, installation tolerance can cause vibrations when a rotor rotates. An unbalanced position and amount of the unbalance of the rotor can be measured by dynamic balance detecting devices. The unbalance of the rotor is lowered by adding or reducing balancing weight block at appropriate positions. However, known dynamic balance detecting devices have complex structures and vibrate significantly when in use, which affects accuracies of the measurements and regulating.

Therefore, there is room for improvement within the art.

### BRIEF DESCRIPTION OF THE DRAWING

The components in the drawings are not necessarily drawn to scale, the emphasis instead being placed upon clearly illustrating the principles of the present disclosure. Moreover, in the drawings, like reference numerals designate corresponding parts throughout the several views.

The FIGURE shows an assembled, isometric view of an embodiment of a dynamic balance detecting device.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

The FIGURE shows a dynamic balance detecting device 100 for detecting and regulating a dynamic balance of a rotor 200. The dynamic balance detecting device 100 includes a support frame 10, a platform 20, a pillar 30, an installation base 40, a main shaft 50, a vibration sensor 60, a rotation sensor 70, a dynamic measuring tester 80, and a controller 90. The platform 20 is supported on the support frame 10. The pillar 30 is connected substantially perpendicularly to the platform 20. The main shaft 50 is connected to the pillar 30 by the installation base 40. The rotor 200 is assembled to the main shaft 50. The main shaft 50 is capable of rotating the rotor 200 at a high speed. The vibration sensor 60 is located on a surface of the main shaft 50 for detecting vibration of the main shaft 50. The rotation sensor 70 is connected to the pillar 30 and is adjacent to the main shaft 50 for detecting a rotation speed of the main shaft 50. The dynamic measuring tester 80 is electrically connected with the vibration sensor 60 and the rotation sensor 70. The dynamic measuring tester 80 is configured for receiving and displaying vibration data obtained by the vibration sensor 60 and receiving rotation data obtained by the rotation sensor 70 in real time to analyze and determine whether dynamic balance of the rotor is within a predetermined tolerance,. Therefore, adjustment of adding or reducing balancing weight in corresponding positions for the rotor 200, is obtained and displayed by the dynamic measuring tester 80 required if the dynamic balance of the rotor is not within a predetermined tolerance. The controller 90 is electrically connected to the main shaft 50, the vibration sensor 60, the rotation sensor 70, and the dynamic measuring tester 80. In one embodiment, the platform 20 and the pillar 30 are made of marble for reducing vibration.

The support frame 10 includes a frame body 11 and four movable foot assemblies 13 separately assembled to the frame body 11. Each movable foot assembly 13 includes a connection base 131, a rolling wheel 133, and an assist foot 135. The connection base 131 is fixed to a bottom portion of the frame body 11. The rolling wheel 133 is rotatably connected to the connection base 131 for conveniently moving the dynamic balance detecting device 100. The assisting foot 135 is connected to the connection base 131 for support the frame body 11.

The pillar 30 is substantially L-shaped. The pillar 30 includes a fixing portion 31, an installation portion 33, and two reinforcing portions 37. One end of the fixing portion 31 is connected to the platform 20. The installation portion 33 extends substantially perpendicularly from another end of the fixing portion 31. The two reinforcing portions 37 are fixed to the platform 20 and opposite sides, respectively, of the fixing portion 31 to mount the fixing portion 31 to the platform 20. Each reinforcing portion 37 includes a first mounting block 371, a second mounting block 373, and two third mounting blocks 375. The first mounting block 371 is fixed to the platform 20. The second mounting block 37 is fixed to the fixing portion 31 and connected substantially perpendicularly to the first mounting block 375. A shape of each of the two third mounting blocks 375 is substantially a right triangle. The two third mounting blocks 375 are connected between two end edges, respectively, of the first mounting block 371 and the second mounting block 373, such that two right angle edges of the third mounting blocks abut the fixing portion 31 and the platform 20. The two third mounting blocks 375 are substantially parallel to each other.

The installation base 40 is substantially sleeve-like and defines a penetrating hole 41 therethrough. The installation base 40 is fixed to an end of the installation portion 33.

The main shaft 50 is received through the penetrating hole 41 and is fixedly connected to the installation base 40. The main shaft 50 is substantially parallel to the fixing portion 31. The main shaft 50 includes a driving portion 51 and a rotary portion 53 connected to the driving portion 51. Vibrations produced by the main shaft 50 are absorbed by the pillar 30 and the platform 20. The rotary portion 53 clamps the rotor 200 and is rotated at a high speed by the driving portion 51.

The vibration sensor 60 is located on a surface of the rotary portion 53 for detecting vibrations of the main shaft 50. The rotation sensor 70 is located adjacent to a side of the main shaft 50 for detecting the rotation speed of the main shaft 50. In the illustrated embodiment, the rotation sensor 70 is a laser sensor.

The dynamic measuring tester 80 includes a testing body 81 and a display screen 83 positioned on the main body 81. The testing body 81 is electrically connected with the vibration sensor 60 and the rotation sensor 70. The testing body 81 receives, analyzes, and calculates vibration data obtained by the vibration sensor 60 and rotation data obtained by the rotation sensor 70. The dynamic measuring tester 80 determines whether the rotor 200 is dynamically balanced as desired. If the rotor 200 is not dynamically balanced, the dynamic measuring tester 80 continuously calculates, and the adjustment data in corresponding positions for the rotor 200 is obtained. The display screen 83 displays the vibration data, the rotation speed data, and the regulating data received and obtained by the testing body 81 in real time. The controller 90 controls the main shaft 50, the vibration sensor 60, the rotation sensor 70, and the dynamic measuring tester 80.

In use, the rotor 200 is clamped by the rotary portion 53. A mark (not shown) is marked on the main shaft 50 for the rotation sensor 70 to obtain the rotation speed of the main shaft 50. The main shaft 50 rotates the rotor 200. The vibration sensor 60 detects the amount of vibration of the main shaft 50 and sends the detected amount to the dynamic measuring tester 80. The rotation sensor 70 detects the rotation speed of the main shaft 50 and sends the detected rotation speed to the dynamic measuring tester 80. The dynamic measuring tester 80 receives, analyzes, judges, and calculates vibration data obtained by the vibration sensor 60 and rotation data obtained by the rotation sensor 70, so that the adjustment is obtained and displayed by the dynamic measuring tester 80. An operator regulates the rotor 200 according to the regulating amount.

The dynamic balance detecting device 100 is a simple structure and convenient to operate. The platform 20 and the pillar 30 are made of marble for reducing vibration. The outer wall of the driving portion 51 is snugly engaged with the inner wall of the penetrating hole 41, then vibrations produced by the main shaft 50 rotating are adsorbed by the pillar 30 and the platform 20. Therefore, detecting and regulating accuracy of the dynamic balance detecting device 100 is improved.

In other embodiments, the support frame 10 can be omitted, the platform 20 can be supported on floor or the like. The installation base 40 can be omitted, and the driving portion is directly fixed on the installation portion 33.

While the present disclosure has been described with reference to particular embodiments, the description is illustrative of the disclosure and is not to be construed as limiting the disclosure. Therefore, various modifications can be made to the embodiments by those of ordinary skill in the art without departing from the true spirit and scope of the disclosure, as defined by the appended claims.

What is claimed is:

1. A dynamic balance detecting device, comprising:
a platform;
a pillar substantially perpendicularly connected to the platform;
a main shaft positioned on the pillar, the main shaft being configured for driving a rotor to rotate;
a vibration sensor positioned adjacent to the main shaft, the vibration sensor being configured for detecting vibration of the main shaft;
a rotation sensor positioned adjacent to the main shaft and spaced from the vibration sensor, the rotation sensor being configured for detecting rotations of the main shaft;
a dynamic measuring tester positioned on the platform, the dynamic measuring tester being configured for receiving vibration data obtained by the vibration sensor and receiving rotation data obtained by the rotation sensor in real time and to analyze and determine whether dynamic balance of the rotor is within a predetermined tolerance, and calculating an amount of adjustment of the dynamic balance required; and
a controller electrically connected with each of the main shaft, the vibration sensor, the rotation sensor and the dynamic measuring tester.

2. The dynamic balance detecting device of claim 1, wherein the pillar comprises a fixing portion and an installation portion extending from an end of the fixing portion away from the platform, the fixing portion is connected to the platform, and the main shaft is fixed on the installation portion.

3. The dynamic balance detecting device of claim 2, wherein the pillar further comprises two reinforcing portions, and the two reinforcing portions are oppositely mounted on the fixing portion away from the installation portion and connected with the platform.

4. The dynamic balance detecting device of claim 3, wherein each of the two reinforcing portions comprises a first mounting block, a second mounting block, and two third mounting blocks, the first mounting block is substantially perpendicularly connected with the second mounting block and fixed to the platform, the two third mounting blocks are respectively positioned on opposite ends of the first mounting block and parallel to each other.

5. The dynamic balance detecting device of claim 1, wherein the dynamic balance detecting device further comprises an installation base fixed on the pillar, a penetrating hole is defined through an end surface of the installation base parallel to the pillar, the main shaft passes through the penetrating hole and is assembled with the penetrating hole.

6. The dynamic balance detecting device of claim 5, wherein the main shaft comprises a driving portion and a rotary portion connected to the driving portion, the driving portion passes through the penetrating hole, and an outer wall of the driving portion is snugly engaged with an inner wall of the penetrating hole.

7. The dynamic balance detecting device of claim 1, wherein the dynamic balance detecting device further comprises a support frame, and the platform is positioned on the support frame.

8. The dynamic balance detecting device of claim 7, wherein the support frame comprises a frame body and four movable foot assemblies each assembled with the frame body, and the platform is positioned on the frame body away from the four moving foot assemblies.

9. The dynamic balance detecting device of claim 8, wherein each of the four movable foot assemblies comprises a connection base and a rolling wheel, the connection base is fixed on the frame body away from the platform, and the rolling wheel is rotatably connected with the connection base.

10. The dynamic balance detecting device of claim 9, wherein the dynamic balance detecting device comprises an assisting foot positioned on the connection base adjacent to the rolling wheel, the assisting foot is configured for support framing the frame body.
